(19) United States
(12) Patent Application Publication
(10) Pub. No.: US 2013/0262546 A1
(43) Pub. Date: Oct. 3, 2013

(54) ARITHMETIC CIRCUIT AND ARITHMETIC METHOD

(71) Applicant: FUJITSU LIMITED, Kawasaki-shi (JP)

(72) Inventors: Kensuke SHINOMIYA, Kawasaki-shi (JP); Kenichi Kitamura, Kawasaki-shi (JP)

(73) Assignee: Fujitsu Limited, Kawasaki-shi (JP)

(21) Appl. No.: 13/736,343

(22) Filed: Jan. 8, 2013

(30) Foreign Application Priority Data
Mar. 30, 2012 (JP) 2012-080529

(51) Int. Cl. G06F 7/483

(52) U.S. Cl. CPC G06F 7/483
USPC 708/495

(57) ABSTRACT

An arithmetic circuit includes a storage circuit configured to store a decimal floating point number in an encoded state, a detection circuit configured to detect a pattern of an arrangement of zeros from a bit pattern of the decimal floating point number by decoding the decimal floating point number stored in the storage circuit, and a leading-zero-count circuit configured to generate data indicative of a number of consecutive zeros starting from a most significant bit or from a least significant bit in a significand of the decimal floating point number in response to a detection result obtained by the detection circuit.

### CROSS-REFERENCE TO RELATED APPLICATIONS

The present application is based upon and claims the benefit of priority from the prior Japanese Patent Application No. 2012-080529 filed on Mar. 30, 2012, with the Japanese Patent Office, the entire contents of which are incorporated herein by reference.

### FIELD

The disclosures herein relate to an arithmetic circuit and an arithmetic method.

### BACKGROUND

Leading zero count (i.e., LZC) is an arithmetic that counts the number of leading zeros in the significand of a floating point number, i.e., an arithmetic that counts the number of consecutive zeros appearing from the most significant bit (i.e., MSB) of the significand. This LZC may be performed as preprocessing for various processes such as a bit-shift operation for aligning digits, normalization of a data string, and an operation for aligning the digits of a quotient obtained by division. An LZC circuit is implemented as hardware in various microprocessors.

In computer systems, binary floating point numbers are generally used in scientific computation such as high performance computing (i.e., HPC). In business computation such as finance and accounting computation, on the other hand, decimal floating point numbers having each digit represented in decimal notation are often used. Currently used data formats for decimal floating point numbers include, for 64-bit data, the DPD (densely packed decimal) format specified in IEEE754-2008 and the Oracle NUMBER format used by Oracle (registered trademark). According to these data formats, data is stored in memory with its significand being in an encoded state.

In order to perform LZC with respect to encoded data, the data is decoded first before performing LZC. In such a case, it has been becoming more and more difficult to achieve desirable data processing speed because decoding and LZC are both heavy processing.
[Patent Document 1] Japanese Laid-open Patent Publication No. 2011-86133

### SUMMARY

According to an aspect of the embodiment, an arithmetic circuit includes a storage circuit configured to store a decimal floating point number in an encoded state, a detection circuit configured to detect a pattern of an arrangement of zeros from a bit pattern of the decimal floating point number by decoding the decimal floating point number stored in the storage circuit, and a leading-zero-count circuit configured to generate data indicative of a number of consecutive zeros starting from a most significant bit or from a least significant bit in a significand of the decimal floating point number in response to a detection result obtained by the detection circuit.

According to an aspect of the embodiment, an arithmetic method includes detecting a pattern of an arrangement of zeros from a bit pattern of a decimal floating point number in an encoded state by decoding the decimal floating point number, and generating data indicative of a number of consecutive zeros starting from a most significant bit or from a least significant bit in a significand of the decimal floating point number in response to a result of detecting the pattern of an arrangement of zeros.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating the DPD data format of a decimal floating point number;

FIGS. 2A and 2B are drawings illustrating a decode table for the significand of a decimal floating point number in the DPD format;

FIG. 3 is a drawing illustrating the Oracle NUMBER data format of a decimal floating point number;

FIG. 4 is a drawing illustrating a decode table for the significand of a decimal floating point number in the Oracle NUMBER format;

FIG. 5 is a drawing illustrating a process sequence performed when performing conventional LZC with respect to a decimal floating point number in the DPD format;

FIG. 6 is a drawing illustrating a process sequence performed when performing conventional LZC with respect to a decimal floating point number in the Oracle NUMBER format;

FIG. 7 is a drawing for explaining the LZC performed after the decoding process illustrated in FIG. 5;

FIG. 8 is a drawing for explaining the operation of a circuit that can perform LZC faster than the circuit that performs LZC after the decoding process as illustrated in FIG. 5 or FIG. 7;

FIG. 9 is a drawing illustrating an example of the configuration of an arithmetic circuit that performs LZC by performing a partial LZC process directly with respect to a decimal floating point number in the DPD format;

FIGS. 10A and 10B are tables specifying the logic operations of zero detecting circuits;

FIG. 11 is a drawing illustrating an example of the configuration of a pattern detecting circuit;

FIG. 12 is a drawing illustrating an example of the configuration of an LZC circuit;

FIG. 13 is a drawing illustrating an example of the configuration of an arithmetic circuit that performs LZC by performing a partial LZC process directly with respect to a decimal floating point number in the Oracle NUMBER format;

FIG. 14 is a table specifying the logic operations of zero detecting circuits;

FIG. 15 is a drawing illustrating an example of the configuration of a pattern detecting circuit;

FIG. 16 is a drawing illustrating an example of the configuration of an arithmetic circuit that performs LZC by performing a partial LZC process directly with respect to a decimal floating point number in the DPD format;

FIGS. 17A and 17B are tables specifying the logic operations of partial LZC circuits;

FIG. 18 is a drawing illustrating an example of the configuration of a partial LZC circuit;

FIG. 19 is a drawing illustrating an example of the configuration of a partial LZC circuit;

FIG. 20 is a drawing illustrating an example of the configuration of an arithmetic circuit that performs LZC by performing a partial LZC process directly with respect to a decimal floating point number in the Oracle NUMBER format;

FIG. 21 is a table specifying the logic operations of partial LZC circuits;

FIG. 22 is a drawing illustrating the configuration of a circuit that decodes the most significant digit of a DPD-format decimal floating point number;

FIG. 23 is a drawing illustrating the configuration of a circuit that decodes a declet of a DPD-format decimal floating point number;

FIG. 24 is a drawing illustrating the configuration of a circuit that detects zero in the most significant digit; and

FIG. 25 is a drawing illustrating the configuration of a circuit that detects the pattern of an arrangement of zeros in a declet.

### DESCRIPTION OF EMBODIMENTS

In the following, embodiments of the invention will be described with reference to the accompanying drawings.

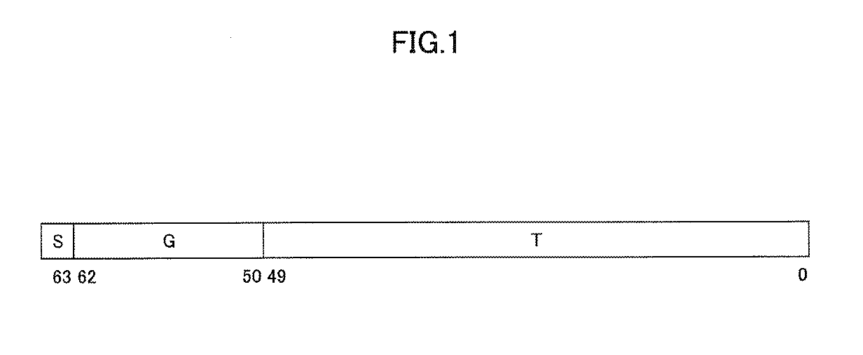

FIG. 1 is a drawing illustrating the DPD data format of a decimal floating point number. A decimal floating point number in the DPD format includes a sign field (S), a combination field (G) and a trailing significand field (T). The sign field is 1 bit long, and stores sign information indicative of the negative or positive sign of the floating point number. The sign field assumes 0 to indicate a positive number and 1 to indicate a negative number. The combination field (G) is 13 bits long, and stores information about the exponent and the MSD (i.e., most significant digit) of the significand. The remaining portion of the significand is stored in the trailing significand field (T). The trailing significand field (T) is 50 bits long. The trailing significand field (T) is divided into a plurality of 10-bit-width blocks (i.e., declets). The term “declet” is the official name of such a block as defined in IEEE754-2008. One declet includes information about 3 digits of a decimal number.

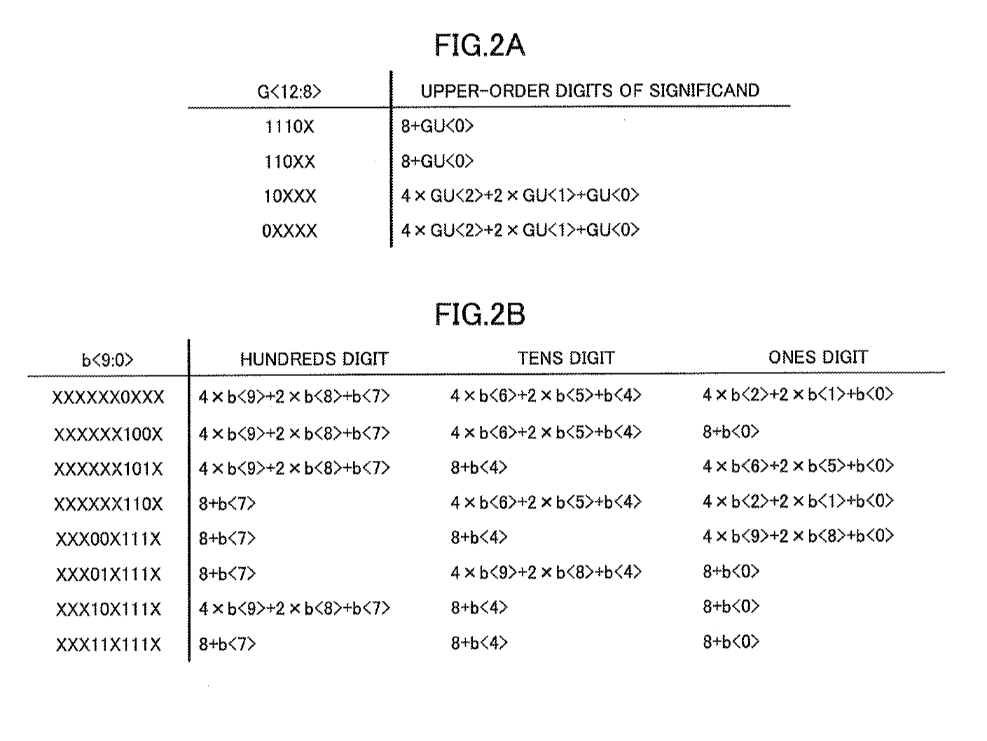

FIGS. 2A and 2B are drawings illustrating a decode table for the significand of a decimal floating point number in the DPD format. The decode table illustrated in FIGS. 2A and 2B may be used to perform decoding in order to obtain a decimal number of each digit from an encoded decimal floating point number in the DPD format.

Specifically, the decode table illustrated in FIG. 2A may be used to decode the combination field (G). In the decode table illustrated in FIG. 2A, G<12:8> represents a 5-bit portion comprised of the 8-th bit to the 12-th bit of the combination field. When G<12:8> is “10XXX” (X indicates “don't care”), the most significant digit decimal number is obtained by calculating 4GU<2>+2GU<1>+GU<0> by using 3 bits GU<2>, GU<1>, and GU<0> of the most significant digit of the significand.

Further, the decode table illustrated in FIG. 2B may be used to decode each declet of the trailing significand field (T). In the decode table illustrated in FIG. 2B, b<9:0> represents 10-bit data comprised of the 0-th bit to the 9-th bit of the declet of interest. b<x> is data of the x-th bit. When b<9:0> is “XXX01X111X” (X indicates “don't care”), the value of the hundreds digit (i.e., the most significant digit of the 3-digit decimal number constituting one declet) is obtained by calculating 8+b<7>. The value of the tens digit is obtained by calculating 4b<9>+2b<8>+b<4>. The value of the ones digit is obtained by calculating 8+b<0>.

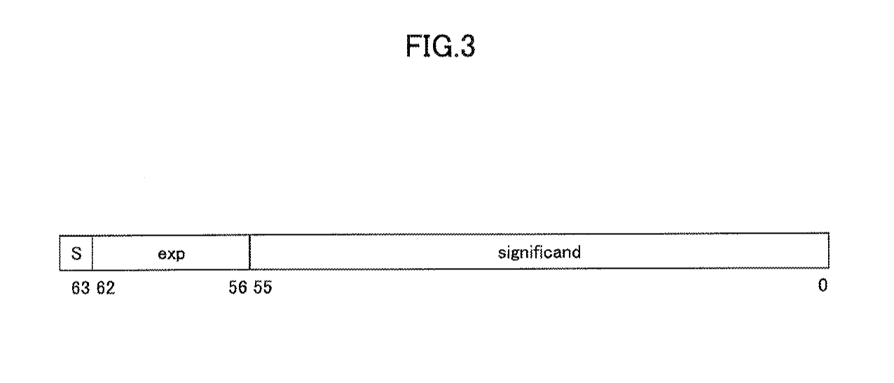

FIG. 3 is a drawing illustrating the Oracle NUMBER data format of a decimal floating point number. A decimal floating point number in the Oracle NUMBER format includes a sign part (S), an exponent part (exp) and a significand part (significand). The sign pat is 1 bit long, and stores sign information indicative of the negative or positive sign of the floating point number. The sign part assumes 0 to indicate a positive number and 1 to indicate a negative number. The exponent part stores information about the exponent, and the significand part stores information about the significand. The significand part is divided into 8-bit blocks. One block includes information about 2 digits of a decimal number.

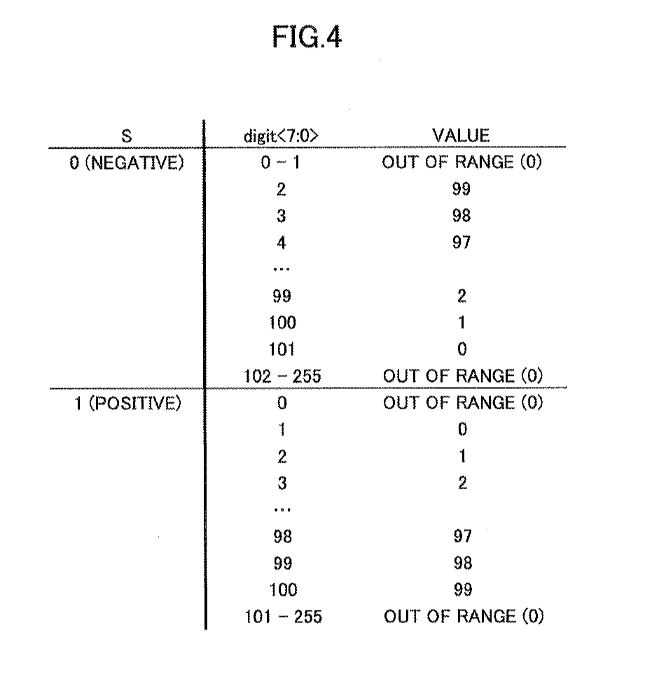

FIG. 4 is a drawing illustrating a decode table for the significand of a decimal floating point number in the Oracle NUMBER format. The decode table illustrated in FIG. 4 may be used to perform decoding in order to obtain a decimal number of each digit from an encoded decimal floating point number in the Oracle NUMBER format. In the decode table illustrated in FIG. 4, digit<7:0> represents 8-bit data comprised of the 0-th bit to the 7-th bit of the block of interest.

Specifically, when the sign part (S) is “0” indicative of a negative number, a two-digit decimal number of the block of interest has a value of 101−a where “a” is the value of digit<7:0>. When the sign part (S) is “1” indicative of a positive number, a two-digit decimal number of the block of interest has a value of a−1 where “a” is the value of digit<7:0>.

In the description that follows, LZC will be described with respect to embodiments in which a decimal floating point number in the DPD format or the Oracle NUMBER format is used. Such embodiments are not intended to be a limiting example.

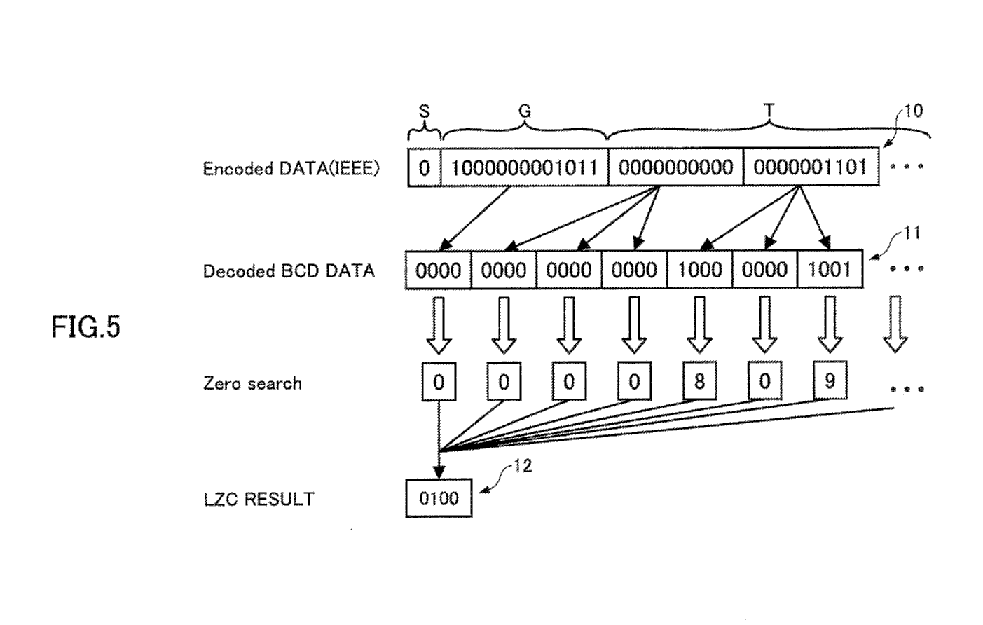

FIG. 5 is a drawing illustrating a process sequence performed when performing conventional LZC with respect to a decimal floating point number in the DPD format. A DPD-format decimal floating point number 10 is an encoded number. The combination field (G) and the trailing significand field (T) of the DPD-format decimal floating point number 10 are decoded to produce decoded decimal number data 11. As was previously described, the combination field (G) is decoded to produce the decimal number of the most significant digit, and each declet of the trailing significand field (T) is decoded to produce three decimal digits. When the decimal numbers of the respective digits are expressed in decimal notation, the resulting number “0000809 . . . ” is obtained. Counting zeros from the most significant digit of this decimal number reveals that the number of “0”s is 4, thus resulting in a LZC result 12 that is “0100” indicative of “4” in binary notation.

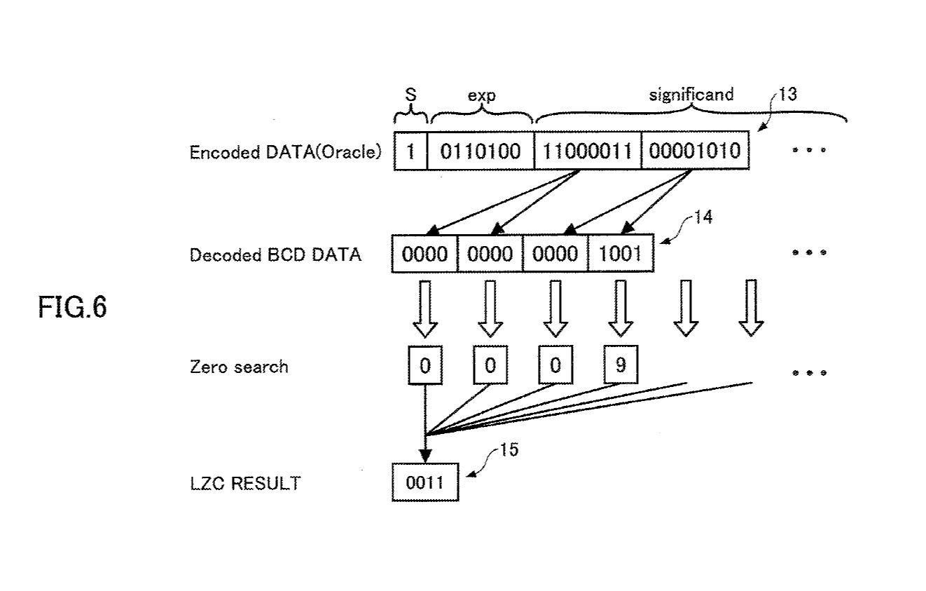

FIG. 6 is a drawing illustrating a process sequence performed when performing conventional LZC with respect to a decimal floating point number in the Oracle NUMBER format. A Oracle-NUMBER-format decimal floating point number 13 is an encoded number. The significand part (significand) of the Oracle-NUMBER-format decimal floating point number 13 is decoded to produce decoded decimal number data 14. As was previously described, each block of the significand is decoded to produce two decimal digits. When the decimal numbers of the respective digits are expressed in decimal notation, the resulting number “0009 . . . ” is obtained. Counting zeros from the most significant digit of this decimal number reveals that the number of “0”s is 3, thus resulting in a LZC result 15 that is “0011” indicative of “3” in binary notation.

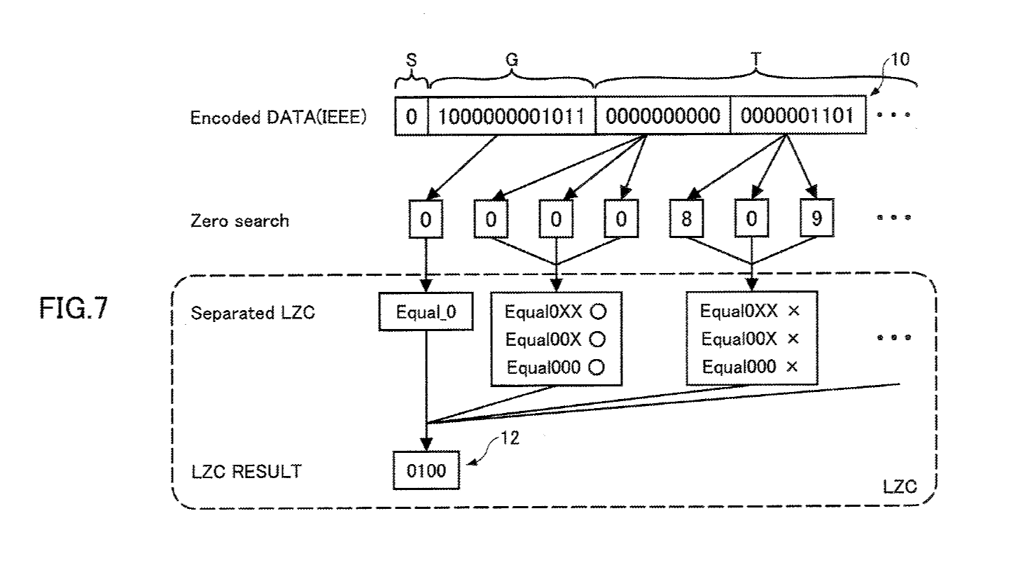

FIG. 7 is a drawing for explaining the LZC performed after the decoding process illustrated in FIG. 5. When the decimal number “0000809 . . . ” is obtained as illustrated in FIG. 7, a partial LZC process is performed with respect to the three decimal digits of each declet to produce a flag indicating that all the three digits are zeros, that the first two digits are zeros, or that the first one digit is zero. This flag indicates the pattern of an arrangement of zeros. Equal0XX is “1” (illustrated as an open circle in FIG. 7) only when the three decimal digits of the declet of interest matches the pattern “0XX” (X indicates “don't care”), and is “0” when they do not match this pattern (illustrated as an X in FIG. 7). By the same token, equal00X is “1” (illustrated as an open circle in FIG. 7) only when the three decimal digits of the declet of interest matches the pattern “00X” (X indicates “don't care”), and is “0” when they do not match this pattern (illustrated as an X in FIG. 7). Further, Equal000 is “1” (illustrated as an open circle in FIG. 7) only when the three decimal digits of the declet of interest matches the pattern “000”, and is “0” when they do not match this pattern (illustrated as an X in FIG. 7). These flags obtained by the partial LZC process are used to produce the LZC result 12 that indicates that the number of leading zeros is 4. As for the most significant digit, Equal_{—}0 is “1” when this digit is equal to “0”, and is “0” when this digit is not equal to “0”.

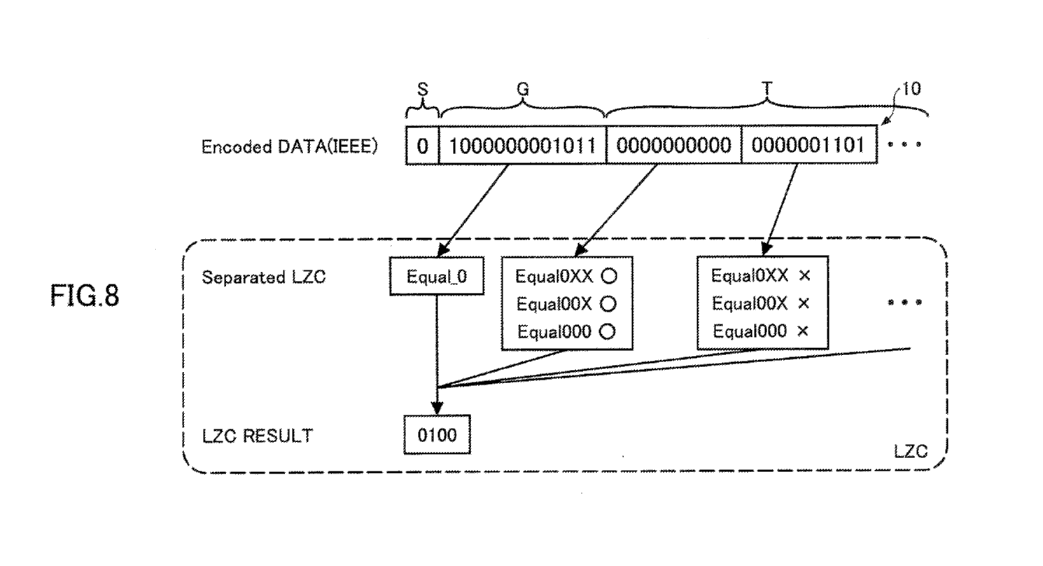

FIG. 8 is a drawing for explaining the operation of a circuit that can perform LZC faster than the circuit that performs LZC after the decoding process as illustrated in FIG. 5 or FIG. 7. In LZC illustrated in FIG. 8, a partial LZC process is performed directly with respect to the DPD-format decimal floating point number 10 without performing a decoding process as illustrated in FIG. 5 or FIG. 7, namely without obtaining the decoded decimal number “0000809 . . . ”, followed by producing the LZC result 12 based on the results of the partial LZC process. Performing the partial LZC process directly with respect to the DPD-format decimal floating point number 10 may involve detecting the presence and absence of zero in each digit directly from the original bit pattern of the DPD-format decimal floating point number 10. Namely, the value of each decimal number is not obtained by applying the rules defined in FIGS. 2A and 2B. Instead, the bit pattern of the DPD-format decimal floating point number 10 is used as an input, based on which a check is directly made as to whether the decimal number of each digit is zero or not. Here, the phrase “detecting the presence and absence of zero in each digit directly from” may mean obtaining a bit value indicative of the presence and absence of zero in each digit directly from the input bit pattern of the DPD-format decimal floating point number 10 by performing AND operations only, which is a logic product arithmetic between plural bit values.

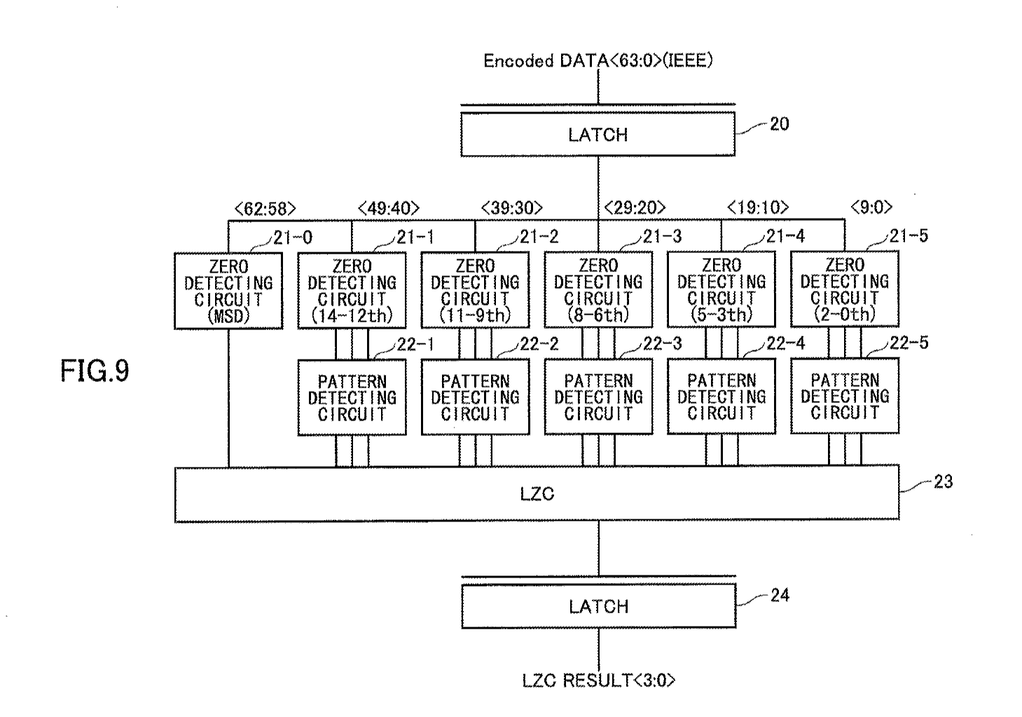

FIG. 9 is a drawing illustrating an example of the configuration of an arithmetic circuit that performs LZC by performing a partial LZC process directly with respect to a decimal floating point number in the DPD format. The arithmetic circuit illustrated in FIG. 9 includes a latch circuit 20, zero detecting circuits 21-0 through 21-5, pattern detecting circuits 22-1 through 22-5, an LZC circuit 23, and a latch circuit 24. The zero detecting circuits 21-0 through 21-5 and the pattern detecting circuits 22-1 through 22-5 are the circuits that perform the partial LZC process.

The latch circuit stores a DPD-format decimal floating point number that is in the encoded state. The zero detecting circuits 21-0 through 21-5 detect the presence and absence of zero in each of the digits directly from the combination field or the declets of the DPD-format decimal floating point number stored in the latch circuit 20. Specifically, the zero detecting circuit 21-0 detects the presence and absence of zero in the most significant digit with respect to the combination field. Further, the zero detecting circuit 21-1, for example, detects the presence and absence of zero in the three digits with respect to the declet that is comprised of the 40-th bit to the 49-th bit of the trailing significand field.

The pattern detecting circuits 22-1 through 22-5 receive the results of zero detections from the zero detecting circuits 21-1 through 21-5, respectively, and detect the pattern of an arrangement of zeros in response to the results of zero detections. Specifically, with respect to the three relevant decimal digits, each of the pattern detecting circuits 22-1 through 22-5 produces a flag indicating that all the three digits are zeros, that the first two digits are zeros, or that the first one digit is zero. The LZC circuit 23 produces binary data indicative of the counted number of leading zeros in response to the output of the zero detecting circuit 21-0 and the outputs of the pattern detecting circuits 22-1 through 22-5. The binary data indicative of the counted number of leading zeros is stored in the latch circuit 24.

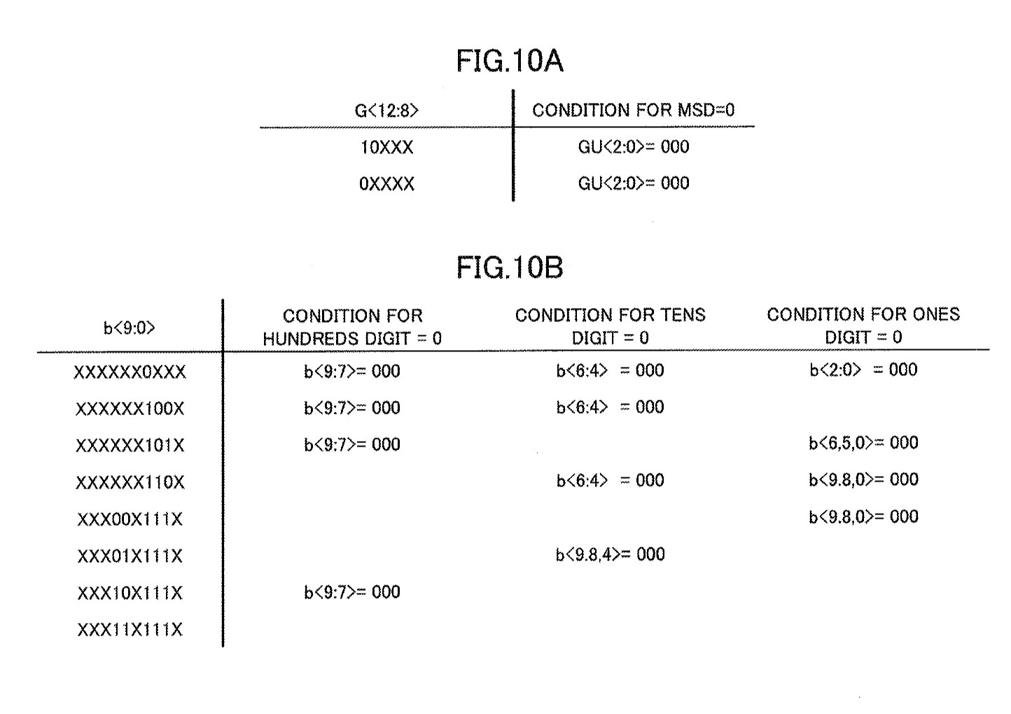

FIGS. 10A and 10B are tables specifying the logic operations of the zero detecting circuits 21-0 through 21-5. The table illustrated in FIGS. 10A and 10B may be used to perform a logic operation in order to detect the presence and absence of zero in each digit from an encoded decimal floating point number in the DPD format.

Specifically, the table illustrated in FIG. 10A may be used to detect the presence and absence of zero in the most significant digit (i.e., MSD) with respect to the combination field (G). In the table illustrated in FIG. 10A, G<12:8> represents a 5-bit portion comprised of the F-th bit to the 12-th bit of the combination field. When G<12:8> is “10XXX” (X indicates “don't care”) or “0XXXX” (X indicates “don't care”), and all the three bits GU<2:0> of the most significant digit of the significand are zeros (i.e., equal to “000”), the most significant digit is “0”. Namely, when the conditions specified in the table of FIG. 10A are satisfied, the zero detecting circuit 21-0 produces data indicative of the presence of zero in the most significant digit. When these conditions are not satisfied, the zero detecting circuit 21-0 produces data indicative of the absence of zero in the most significant digit.

The table illustrated in FIG. 10B may be used to detect the presence and absence of zero in each of the digits of each declet included in the trailing significand field (T). In the table illustrated in FIG. 10B, b<9:0> represents 10-bit data comprised of the 0-th bit to the 9-th bit of the declet of interest. b<x:y> is data comprised of the x-th bit to the y-th bit. When b<9:0> is “XXXXXX101X” (X indicates “don't care”), the fact that all the three bits b<9:7> are zeros (i.e., equal to “000”) indicates that the value of the hundreds digit (i.e., the most significant digit of the 3-digit decimal number constituting one declet) is 0. Namely, when these conditions are satisfied for any given one of the zero detecting circuits 21-1 through 21-5, such a zero detecting circuit produces data indicative of the presence of zero in the most significant digit. When these conditions are not satisfied, the zero detecting circuit produces data indicative of the absence of zero in the most significant digit. By the same token, when b<9:0> is “XXXXXX101X” (X indicates “don't care”), the fact that all the three bits b<6, 5, 0> (i.e., the sixth bit, the fifth bit, and the 0-th bit) are zeros (i.e., equal to “000”) indicates that the value of ones digit is 0. Namely, when these conditions are satisfied for any given one of the zero detecting circuits 21-1 through 21-5, such a zero detecting circuit produces data indicative of the presence of zero in the least significant digit. When these conditions are not satisfied, the zero detecting circuit produces data indicative of the absence of zero in the least significant digit. It may be noted that with respect to the digit position for which no entry is given in the table, data indicative of the absence of zero is produced.

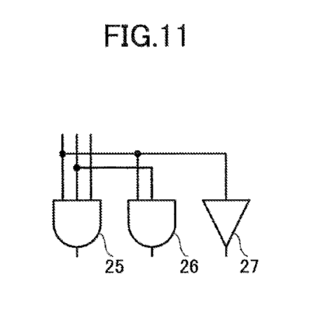

FIG. 11 is a drawing illustrating an example of the configuration of the pattern detecting circuit. Each of the pattern detecting circuits 22-1 through 22-5 illustrated in FIG. 9 may have the same circuit configuration as that illustrated in FIG. 10. The circuit illustrated in FIG. 11 includes an AND gate 25, an AND gate 26, and a buffer circuit 27. The three input bits are, from left to right, a bit indicative of the presence and absence of zero in the hundreds digit, a bit indicative of the presence and absence of zero in the tens digit, and a bit indicative of the presence and absence of zero in the ones digit. Each bit assumes “1” to indicate the presence of zero and “0” to indicate the absence of zero. The AND gate 25 outputs “1” when all the three digits are zeros, and outputs “0” otherwise. The AND gate 26 outputs “1” when all the two upper-order digits of the three digits are zeros, and outputs “0” otherwise. The buffer circuit 27 outputs “1” when the most significant one of the three digits is zero, and outputs “0” otherwise.

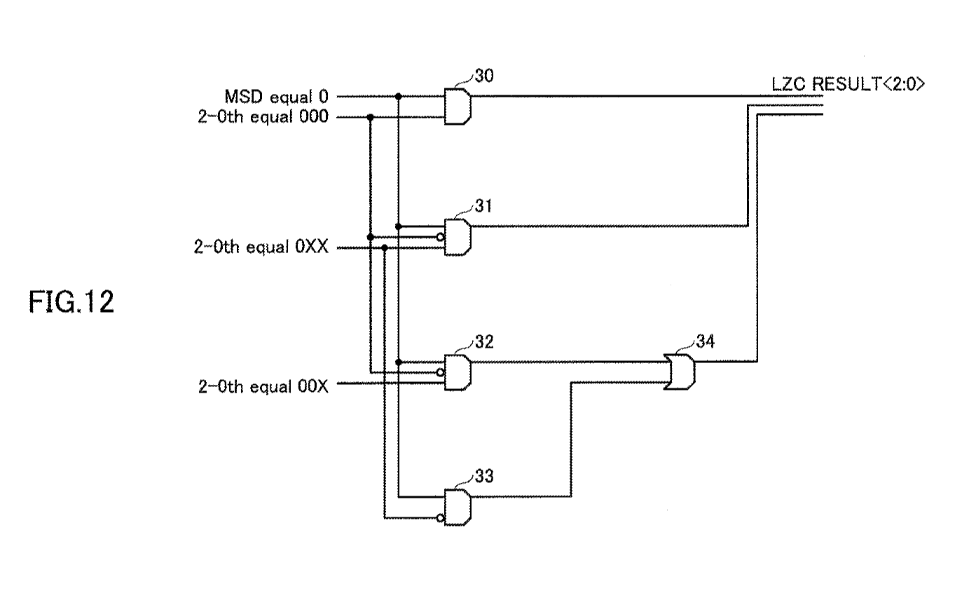

FIG. 12 is a drawing illustrating an example of the configuration of the LZC circuit 23. The arithmetic circuit illustrated in FIG. 9 is supposed to process a decimal number that has 16 digits in total. FIG. 12 illustrates a circuit that takes into account only the first four digits for the sake of simplicity of explanation since the logic circuit that calculates the number of leading zeros for all the sixteen digits would be too complex to describe with clarity. This circuit calculates the number of leading zeros that is within the range of 0 to 3 based on the outputs of the zero detecting circuit 21-0 and the pattern detecting circuit 22-1. The same or similar design principle may be applied to the construction of a logic circuit that counts leading zeros with respect to all the sixteen digits.

The circuit illustrated in FIG. 12 includes AND gates 30 through 33 and an OR gate 34 for performing a logical sum operation. There are 4 incoming bits in total. One bit (MSD equal 0) is supplied from the zero detecting circuit 21-0 to indicate the presence and absence of zero in the most significant bit. Three bits regarding the arrangement of zeros in three digits are supplied from the pattern detecting circuit 22-1. These three bits include a bit (2-0th equal 000) that becomes “1” when all the three digits are zeros, a bit (2-0th equal 00X) that becomes “L” when all the two upper-order digits are zeros, and a bit (2-0th equal 0XX) that becomes “1” when the most significant bit is zero.

The output (LZC RESULT<2:0>) is 3-bit data, which represents the number of leading zeros in binary notation. The output bit of the AND gate 30 is the most significant bit in the 2² digit place. The output bit of the AND gate 31 is the bit in the 2¹ digit place. The output bit of the OR gate 34 is the least significant bit in the 2⁰ digit place. The bit (2-0th equal 000) that becomes “1” when all the three digits are zeros may be “0”, and the bit (2-0th equal 00×) that becomes “1” when all the two upper-order digits are zeros may be “0”. Also, the bit (2-0th equal 0XX) that becomes “1” when the most significant bit is zero may be “1”. Further, the bit (MSD equal 0) that indicates the presence and absence of zero in the most significant bit may be “1”, indicating the presence of zero in the most significant bit. These conditions correspond to the case in which the number of leading zeros is 2, i.e., MSD is zero, and the three following digits are “010”. In this case, the output is “010”, which is equal to “2”, and agrees with the fact that the number of leading zeros is two.

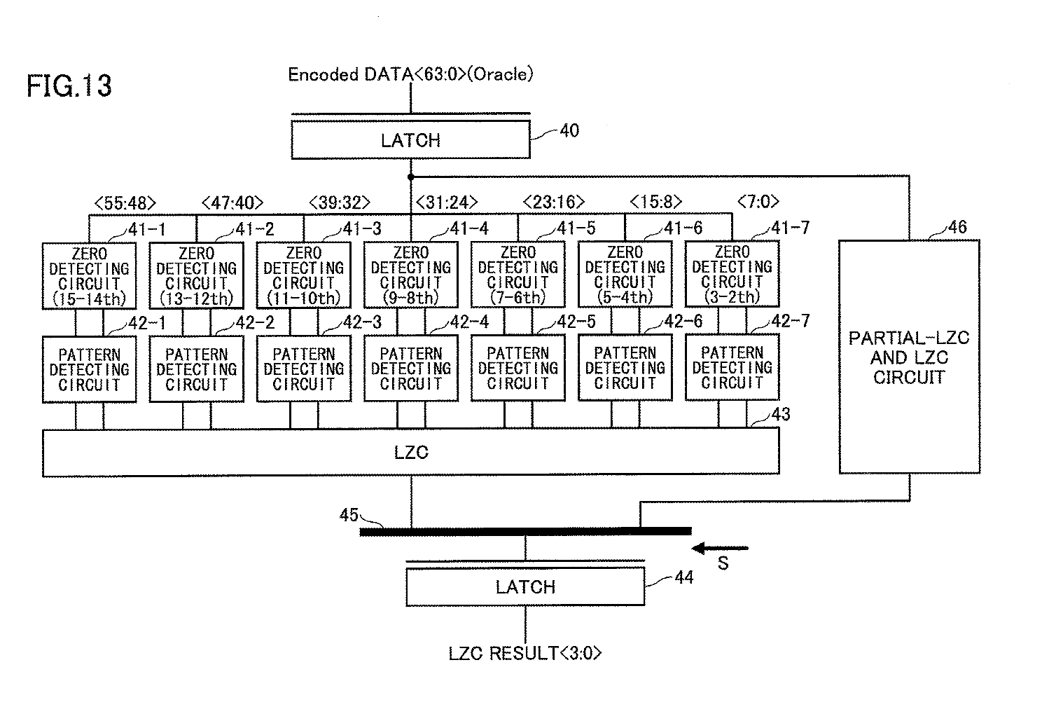

FIG. 13 is a drawing illustrating an example of the configuration of an arithmetic circuit that performs LZC by performing a partial LZC process directly with respect to a decimal floating point number in the Oracle NUMBER format. The arithmetic circuit illustrated in FIG. 13 includes a latch circuit 40, zero detecting circuits 41-1 through 41-7, pattern detecting circuits 42-1 through 42-7, an LZC circuit 43, a latch circuit 44, a selector 45, and a partial-LZC and LZC circuit 46. The zero detecting circuits 41-1 through 41-7 and the pattern detecting circuits 42-1 through 42-7 are the circuits that perform the partial. LZC process.

The zero detecting circuits 41-1 through 41-7, the pattern detecting circuits 42-1 through 42-7, and the LZC circuit 43 constitute the circuit that counts the number of leading zeros when the sign part (S) indicates a positive number, for example. The partial-LZC and LZC circuit 46 constitutes the circuit that counts the number of leading zeros when the sign part (S) indicates a negative number, for example. The partial-LZC and LZC circuit 46 may have the same or similar block configuration as the circuit that counts the number of leading zeros when the sign part (S) indicates a positive number. Namely, the partial-LZC and LZC circuit 46 may include a plurality of zero detecting circuits, a plurality of pattern detecting circuits, and a LZC circuit. It is noted that the logic configuration of the zero detecting circuits differs between the case of the sign part (S) indicting a positive number and the case of the sign part (S) indicating a negative number.

The calculated value (i.e., the output of the LZC circuit 43) obtained in the case of the sign part (S) indicating a positive number and the calculated value (i.e., the output of the partial-LZC and LZC circuit 46) obtained in the case of the sign part (S) indicating a negative number are supplied to the selector 45. The selector 45 performs a selecting operation by using the value of the sign part (S) as a selection signal. Through this selection process, the output of the LZC circuit 43 is stored in the latch circuit 44 in the case of the sign part (S) indicating a positive number, and the output of the partial-LZC and LZC circuit 46 is stored in the latch circuit 44 in the case of the sign part (S) indicating a negative number.

The latch circuit stores a Oracle-NUMBER-format decimal floating point number that is in the encoded state. The zero detecting circuits 41-1 through 41-7 detect the presence and absence of zero in each of the digits directly from the bit patterns of the respective blocks of the Oracle-NUMBER-format decimal floating point number stored in the latch circuit 40. Namely, the value of each decimal number is not obtained by applying the rules defined in FIG. 4. Instead, the bit pattern of the Oracle-NUMBER-format decimal floating point number is used as an input, based on which a check is directly made as to whether the decimal number of each digit is zero or not. Here, the phrase “a check is directly made as to whether the decimal number of each digit is zero or not” may mean obtaining a bit value indicative of the presence and absence of zero in each digit based on a determination as to whether an 8-bit bit pattern of the decimal floating point number 10 falls within a range of values corresponding to a zero value of the corresponding digits. The zero detecting circuit 41-1, for example, detects the presence and absence of zero in the two digits with respect to the block that is comprised of the 48-th bit to the 55-th bit of the significand part.

The pattern detecting circuits 42-1 through 42-7 receive the results of zero detections from the zero detecting circuits 41-1 through 41-7, respectively, and detect the pattern of an arrangement of zeros in response to the results of zero detections. Specifically, with respect to the two relevant decimal digits, each of the pattern detecting circuits 42-1 through 42-7 produces a flag indicating that all the two digits are zeros or that the first one digit is zero. The LZC circuit 43 produces binary data indicative of the counted number of leading zeros in response to the outputs of the pattern detecting circuits 42-1 through 42-7. The binary data indicative of the counted number of leading zeros is stored in the latch circuit 44 via the selector 45.

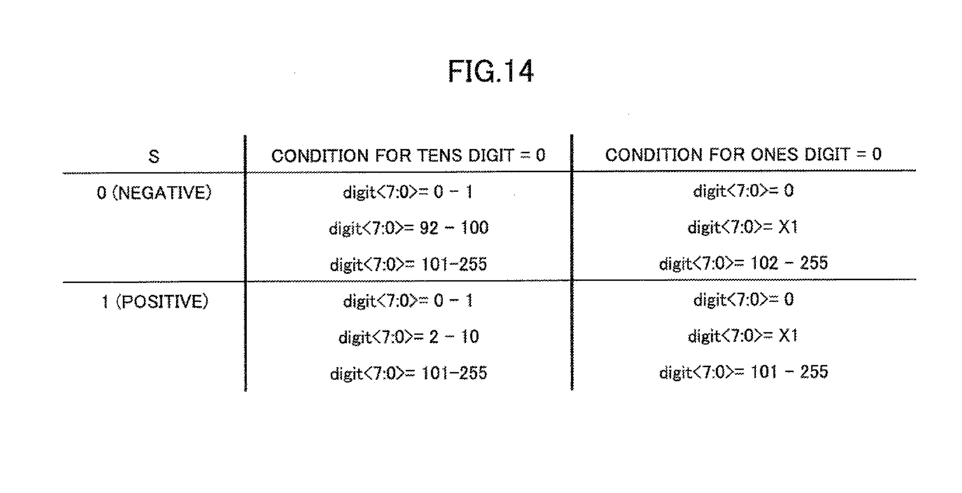

FIG. 14 is a table specifying the logic operations of the zero detecting circuits 41-1 through 41-7. The table illustrated in FIG. 14 may be used to perform a logic operation in order to detect the presence and absence of zero in each digit from an encoded decimal floating point number in the Oracle-NUMBER format. In the table illustrated in FIG. 14, digit<7:0> represents 8-bit data comprised of the 0-th bit to the 7-th bit of the block of interest.

In the case of the sign part (S) being 0 indicative of a negative number, for example, the fact that the numerical value specified by digit<7:0> falls within a range of 0 to 1 (inclusive), a range of 92 to 100 (inclusive), or a range of 101 to 255 (inclusive) means that the tens digit of the decimal number is zero. By the same token, in the case of the sign part (S) being 0 indicative of a negative number, the fact that the numerical value specified by digit<7:0> is 0, “X1” (X is “don't care”), or within a range of 102 to 255 (inclusive) means that the ones digit of the decimal number is zero. Similarly, the table illustrated in FIG. 14 may be used in the case of the sign part (S) being 1 indicative of a positive number.

When the condition indicating that the least significant digit is zero is satisfied for any given one of the zero detecting circuits 41-1 through 41-7, for example, such a zero detecting circuit produces data indicative of the presence of zero in the least significant digit. When the condition indicating that the least significant digit is zero is not satisfied, the zero detecting circuit produces data indicative of the absence of zero in the least significant digit.

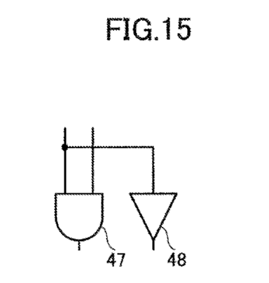

FIG. 15 is a drawing illustrating an example of the configuration of the pattern detecting circuit. Each of the pattern detecting circuits 42-1 through 42-7 illustrated in FIG. 13 may have the same circuit configuration as that illustrated in FIG. 15. The circuit illustrated in FIG. 11 includes an AND gate 47 and a buffer circuit 48. The two input bits are, from left to right, a bit indicative of the presence and absence of zero in the tens digit and a bit indicative of the presence and absence of zero in the ones digit. Each bit assumes “1” to indicate the presence of zero and “0” to indicate the absence of zero. The AND gate 47 outputs “1” when both of the two digits are zeros, and outputs “0” otherwise. The buffer circuit 48 outputs “1” when the most significant one of the two digits is zero, and outputs “0” otherwise.

By referring to FIG. 13 again, the LZC circuit 43 counts the number of leading zeros with respect to the outputs of the pattern detecting circuits 42-1 through 42-7. The result of counting, e.g., binary data indicative of the counted number, is output from the LZC circuit 43. The specific circuit configuration of the LZC circuit 43 is not described here. A circuit having a similar configuration to the logic circuit illustrated in FIG. 12 may be used and designed as a logic circuit that produces binary value responsive to the number of leading zeros.

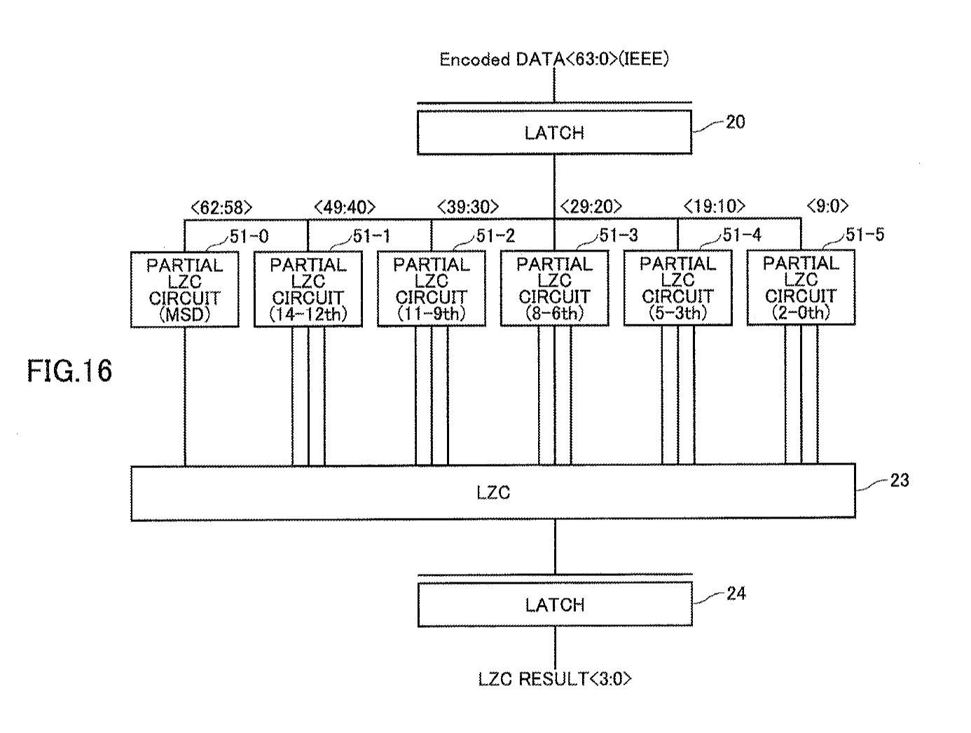

FIG. 16 is a drawing illustrating an example of the configuration of an arithmetic circuit that performs LZC by performing a partial LZC process directly with respect to a decimal floating point number in the DPD format. The circuit configuration illustrated in FIG. 9 detects zero in each digit, and detects the pattern of an arrangement of zeros based on the results of zero detection, followed by counting the number of leading zeros based on the results of detecting the zero arrangement pattern. On the other hand, the circuit configuration illustrated in FIG. 16 obtains the pattern of an arrangement of zeros directly from a decimal floating point number in the DPD format.

The arithmetic circuit illustrated in FIG. 16 includes a latch circuit 20, partial LZC circuits 51-0 through 51-5, an LZC circuit 23, and a latch circuit 24. In FIG. 16, the same or corresponding elements as those of FIG. 9 are referred to by the same or corresponding numerals, and a description thereof will be omitted as appropriate. The circuit configuration illustrated in FIG. 9 detects zero in each digit, and detects the pattern of an arrangement of zeros based on the results of zero detection, followed by counting the number of leading zeros based on the results of detecting the zero arrangement pattern. In the configuration illustrated in FIG. 16, on the other hand, the partial LZC circuits 51-0 through 51-5 directly detect the pattern of an arrangement of zeros based on the combination field or the declets of the DPD-format decimal floating point number stored in the latch circuit 20. Specifically, the partial LZC circuit 51-0 detects the presence and absence of zero in the most significant digit with respect to the combination field. Further, the partial LZC circuit 51-1, for example, detects the pattern of an arrangement of zeros in the three digits with respect to the declet that is comprised of the 40-th bit to the 49-th bit of the trailing significand field. Specifically, with respect to the three relevant decimal digits, each of the partial LZC circuits 51-0 through 51-5 produces a flag indicating that all the three digits are zeros, that the first two digits are zeros, or that the first one digit is zero. The LZC circuit 23 produces binary data indicative of the counted number of leading zeros in response to the outputs of the partial LZC circuits 51-0 through 51-5. The binary data indicative of the counted number of leading zeros is stored in the latch circuit 24.

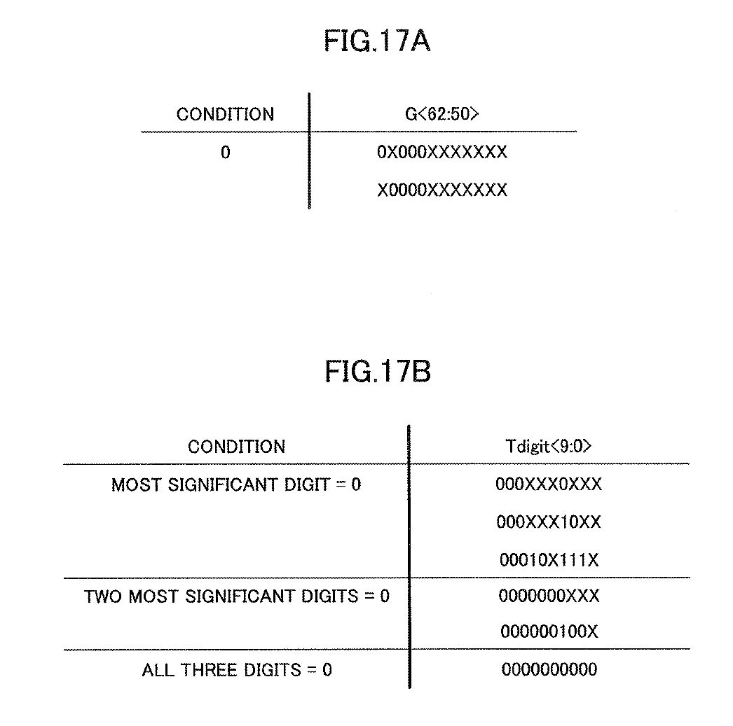

FIGS. 17A and 17B are tables specifying the logic operations of the partial LZC circuits 51-0 through 51-5. The table illustrated in FIGS. 17A and 17B may be used to perform a logic operation in order to detect the pattern of an arrangement of zeros from an encoded decimal floating point number in the DPD format.

Specifically, the table illustrated in FIG. 17A may be used to detect the presence and absence of zero in the most significant digit with respect to the combination field (G). In the table illustrated in FIG. 17A, G<62:50> represents the 13-bit-width data of the combination field (G). The fact that G<62:50> is “0X000XXXXXXX” (X is “don't care”) or “X000XXXXXXX” (X is “don't care”) indicates that the most significant digit is zero. Namely, when the conditions specified in the table of FIG. 17A are satisfied, the partial LZC circuit 51-0 produces data indicative of the presence of zero in the most significant digit. When these conditions are not satisfied, the partial LZC circuit 51-0 produces data indicative of the absence of zero in the most significant digit.

The table illustrated in FIG. 17B may be used to detect the pattern of an arrangement of zeros for each declet included in the trailing significand field (T). In the table illustrated in FIG. 17B, Tdigit<9:0> represents 10-bit data comprised of the 0-th bit to the 9-th bit of the declet of interest. The fact that Tdigit<9:0> is “0000000XXX” (X is “don't care”) or “000000100X” (X is “don't care”) indicates that the two most significant digits are zeros. Namely, when these conditions are satisfied for any given one of the partial LZC circuits 51-0 through 51-5, such a partial LZC circuit sets “1” to a bit indicating that the two most significant bits are zeros. When these conditions are not satisfied, the partial LZC circuit sets “0” to a bit indicating that the two most significant digits are zeros.

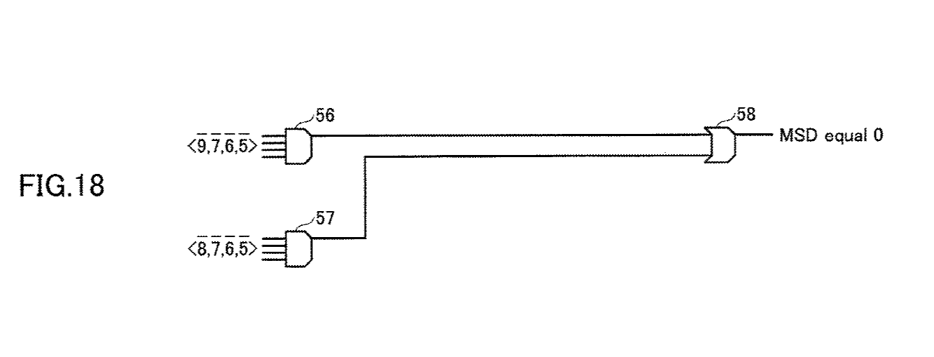

FIG. 18 is a drawing illustrating an example of the configuration of a partial LZC circuit. The circuit illustrated in FIG. 18 corresponds to the partial LZC circuit 51-0. The partial LZC circuit 51-0 illustrated in FIG. 18 includes AND gates 56 and 57 and an OR gate 58. The logic circuit illustrated in FIG. 18 serves to detect the conditions illustrated in FIG. 17A. Namely, the AND gate 56 outputs “1” when the fifth bit, the sixth bit, the seventh bit, and the ninth bit of Tdigit<9:0> are all zeros. Further, the AND gate 57 outputs “1” when the fifth bit, the sixth bit, the seventh bit, and the eight bit of Tdigit<9:0> are all zeros. The OR gate 58 outputs a result obtained by performing an OR operation between the output of the AND gate 56 and the output of the AND gate 57.

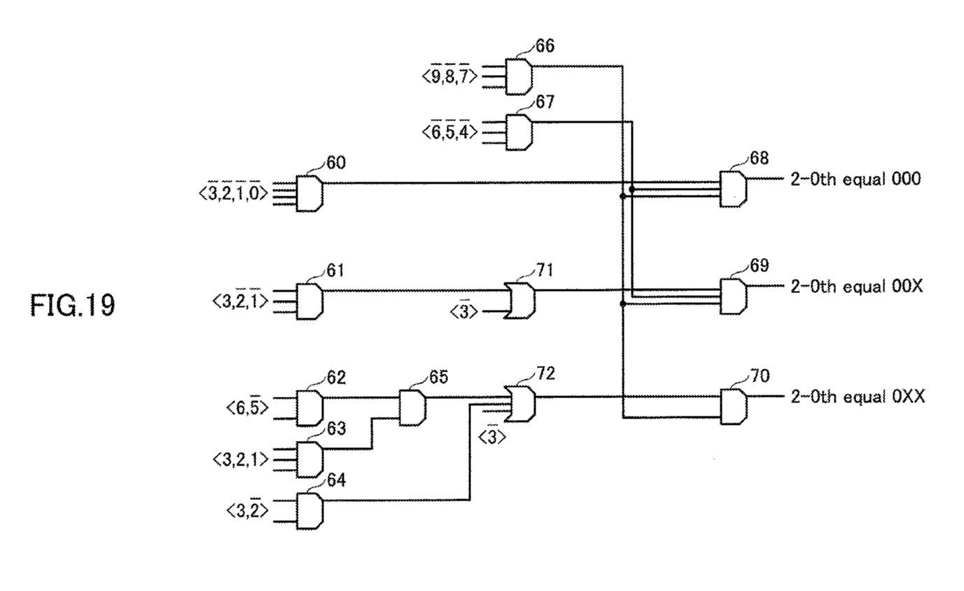

FIG. 19 is a drawing illustrating an example of the configuration of a partial LZC circuit. The circuit illustrated in FIG. 19 corresponds to any one of the partial LZC circuits 51-1 through 51-5. The partial LZC circuit illustrated in FIG. 19 includes AND gates 60 through 70 and OR gates 71 and 72. The logic circuit illustrated in FIG. 19 serves to detect the conditions illustrated in FIG. 17B.

By referring to FIG. 16 again, the arithmetic circuit illustrated in FIG. 16 uses the partial LZC circuits 51-0 through 51-5 to detect the pattern of an arrangement of zeros directly from the bit pattern of a decimal floating point number in the DPD format. The conditions that are defined in FIGS. 17A and 17B and are to be detected by the partial LZC circuits 51-0 through 51-5 illustrated in FIG. 16 are simpler than the conditions that are defined in FIGS. 10A and 10B and are to be detected by the zero detecting circuits 21-0 through 21-5 illustrated in FIG. 9. Further, the arithmetic circuit illustrated in FIG. 16 does not have zero detecting circuits and pattern detecting circuits separate therefrom as in the arithmetic circuit illustrated in FIG. 9. With this arrangement, the arithmetic circuit illustrated in FIG. 16 has a reduced circuit size compared with the arithmetic circuit illustrated in FIG. 9.

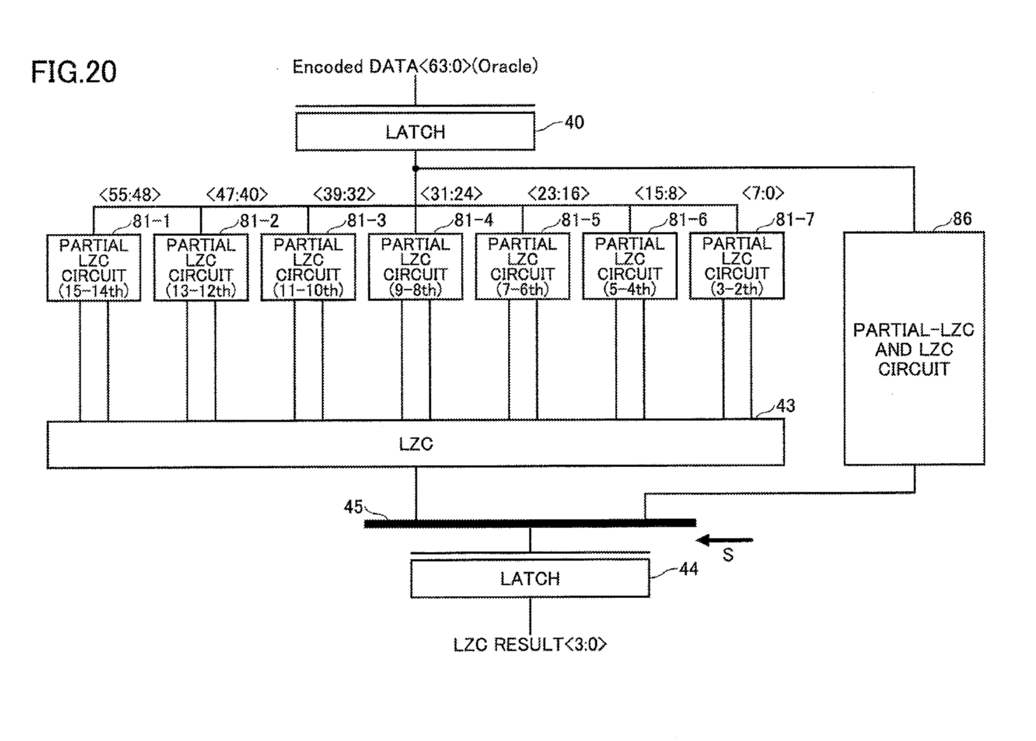

FIG. 20 is a drawing illustrating an example of the configuration of an arithmetic circuit that performs LZC by performing a partial LZC process directly with respect to a decimal floating point number in the Oracle NUMBER format. The circuit configuration illustrated in FIG. 13 detects zero in each digit, and detects the pattern of an arrangement of zeros based on the results of zero detection, followed by counting the number of leading zeros based on the results of detecting the zero arrangement pattern. On the other hand, the circuit configuration illustrated in FIG. 20 obtains the pattern of an arrangement of zeros directly from a decimal floating point number in the Oracle-NUMBER format.

The arithmetic circuit illustrated in FIG. 20 includes a latch circuit 40, partial LZC circuits 81-1 through 81-7, an LZC circuit 43, a latch circuit 44, a selector 45, and a partial-LZC and LZC circuit 86. In FIG. 20, the same or corresponding elements as those of FIG. 13 are referred to by the same or corresponding numerals, and a description thereof will be omitted as appropriate. The circuit configuration illustrated in FIG. 13 detects zero in each digit, and detects the pattern of an arrangement of zeros based on the results of zero detection, followed by counting the number of leading zeros based on the results of detecting the zero arrangement pattern. In the configuration illustrated in FIG. 20, on the other hand, the partial LZC circuits 81-1 through 81-7 directly detect the pattern of an arrangement of zeros based on the bit patterns of the respective blocks of the Oracle-NUMBER-format decimal floating point number stored in the latch circuit 40. Specifically, the partial LZC circuit 81-1, for example, detects the pattern of an arrangement of zeros in the two digits with respect to the 8-bit-width block that is comprised of the 48-th bit to the 55-th bit of the significand part. With respect to the two relevant decimal digits, each of the partial LZC circuits 81-1 through 81-7 produces a flag indicating that all the two digits are zeros or that the first one digit is zero. The LZC circuit 23 produces binary data indicative of the counted number of leading zeros in response to the outputs of the partial LZC circuits 81-1 through 81-7. The binary data indicative of the counted number of leading zeros is stored in the latch circuit 44.

The partial LZC circuits 81-1 through 81-7 and the LZC circuit 43 constitute a circuit portion that counts the number of leading zeros when the sign part (S) indicates a positive number, for example. The partial-LZC and LZC circuit 86 constitutes the circuit that counts the number of leading zeros when the sign part (S) indicates a negative number, for example. The partial-LZC and LZC circuit 86 may have the same or similar block configuration as the circuit that counts the number of leading zeros when the sign part (S) indicates a positive number. Namely, the partial-LZC and LZC circuit 86 may include a partial-LZC circuit and an LZC circuit. It is noted that the logic configuration of the partial-LZC circuits differs between the case of the sign part (S) indicting a positive number and the case of the sign part (S) indicating a negative number.

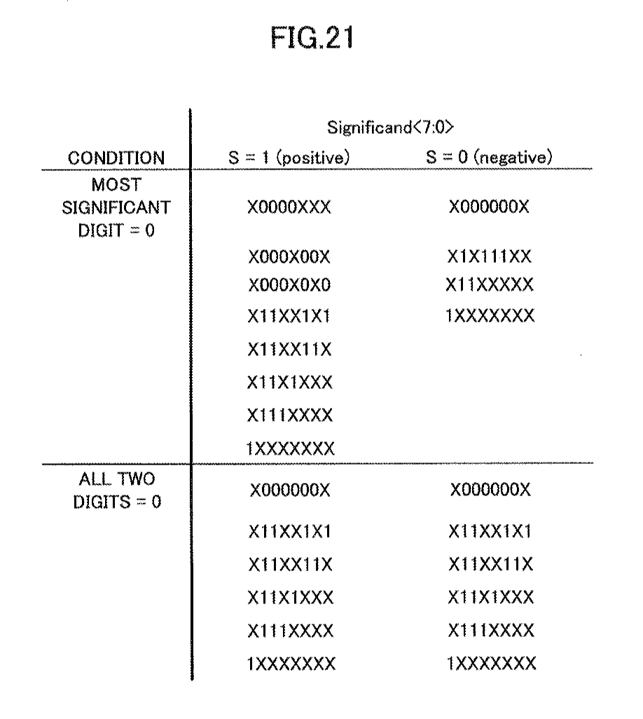

FIG. 21 is a table specifying the logic operations of the partial LZC circuits 81-1 through 81-7. The table illustrated in FIG. 21 may be used to perform a logic operation in order to detect the pattern of an arrangement of zeros from an encoded decimal floating point number in the Oracle-NUMBER format. In the table illustrated in FIG. 21, Significand<7:0> represents 8-bit data comprised of the 0-th bit to the 7-th bit of the block of interest.

FIG. 21 lists 8 bit patterns “X0000XXX” to “1XXXXXXX” at the intersection between the row specified by the condition “One Leading Digit 0” and the column specified by the sign part (S) being “1” indicative of a positive number. When the 8-bit-width data of a block of interest matches any one of these 8 bit patterns, the one leading digit is zero in the case of a positive number. Namely, when these conditions are satisfied for any given one of the partial LZC circuits 81-0 through 81-7, such a partial LZC circuit sets “1” to a bit indicating that the most significant digit is zero. When these conditions are not satisfied, the partial LZC circuit sets “0” to a bit indicating that the most significant digit is zero.

In the following, circuit size is compared between the arithmetic circuit illustrated in FIG. 16 and an arithmetic circuit that decodes a DPD-format decimal floating point number and performs an LZC with respect to the obtained result of decoding.

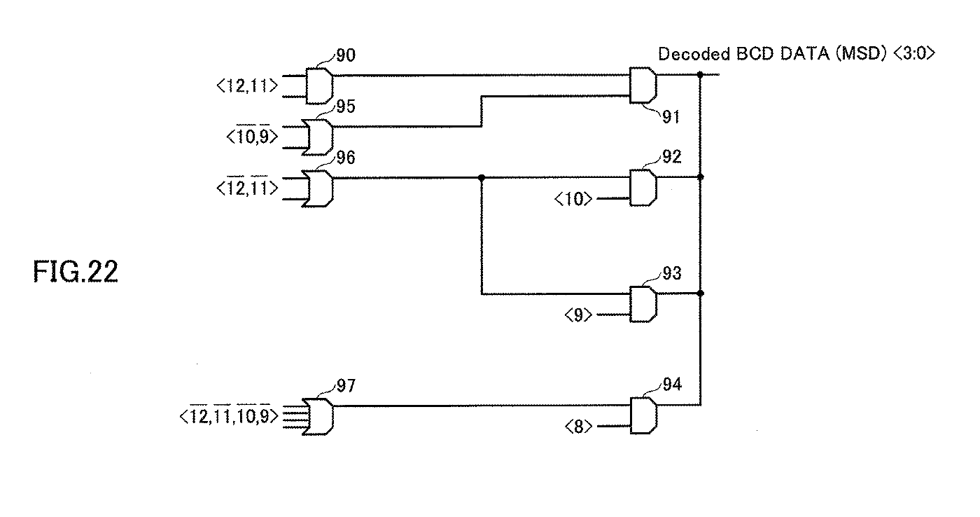

FIG. 22 is a drawing illustrating the configuration of a circuit that decodes the most significant digit of a DPD-format decimal floating point number. The decoding circuit illustrated in FIG. 22 includes AND gates 90 through 94 and OR gates 95 through 97.

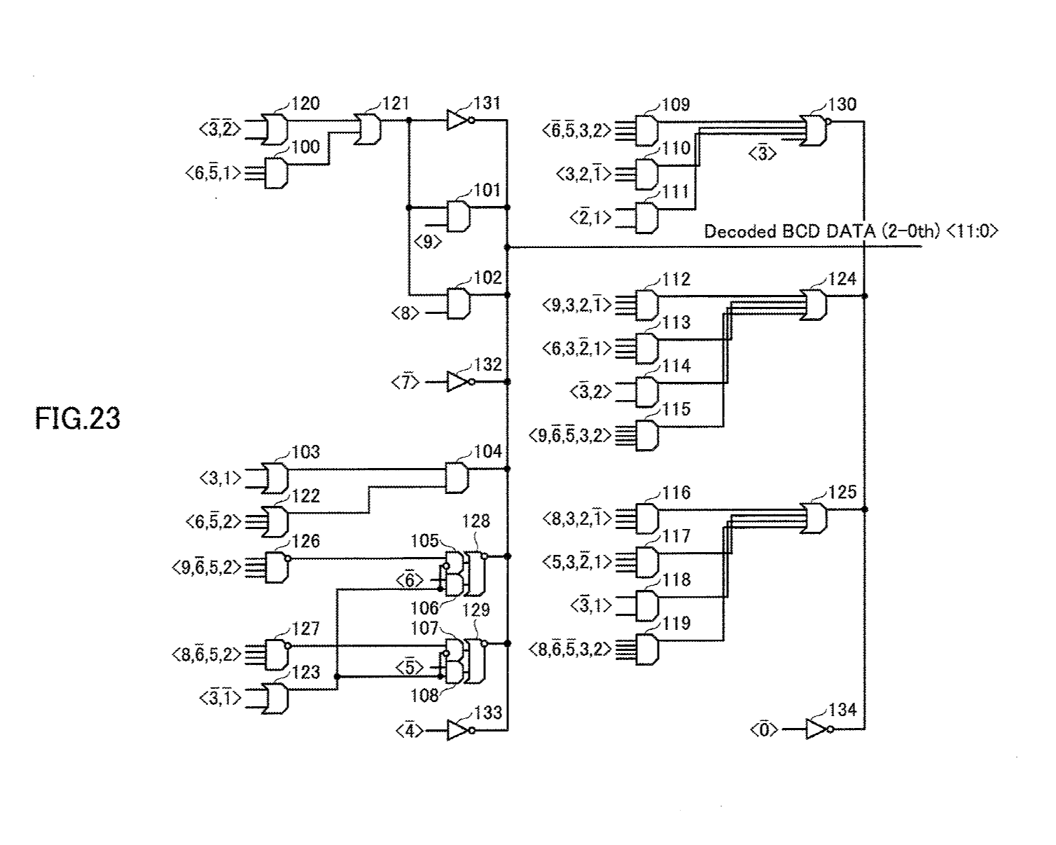

FIG. 23 is a drawing illustrating the configuration of a circuit that decodes a declet of a DPD-format decimal floating point number. The decoding circuit illustrated in FIG. 23 includes AND gates 100 through 119, OR gates 120 through 125, NAND gates 126 and 127, NOR gates 128 through 130, and inverters 131 through 134.

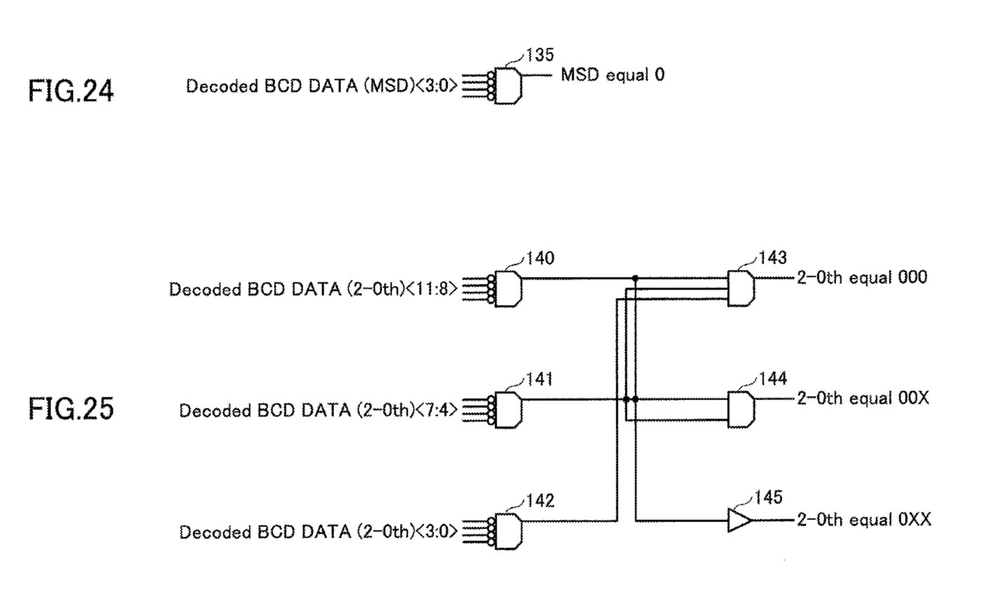

FIG. 24 is a drawing illustrating the configuration of a circuit that detects zero in the most significant digit. The circuit illustrated in FIG. 24 includes an AND gate 135.

FIG. 25 is a drawing illustrating the configuration of a circuit that detects the pattern of an arrangement of zeros in a declet. The circuit illustrated in FIG. 25 includes an AND gates 140 through 144 and a buffer circuit 145.

Using the circuit configurations illustrated in FIG. 23 through FIG. 25, a total of 23 transistor stages may be necessary in order to generate data indicative of the result of detecting a zero arrangement pattern (i.e., the data that can be fed to the LZC circuit 23) from a decimal floating point number in the DPD format. Using the circuit configurations illustrated in FIG. 18 and FIG. 19, on the other hand, a total of 15 transistor stages may suffice in order to generate data indicative of the result of detecting a zero arrangement pattern (i.e., the data that can be fed to the LZC circuit 15) from a decimal floating point number in the DPD format.

In this manner, the arithmetic circuits illustrated in FIG. 9, FIG. 13, FIG. 16, and FIG. 20 achieve high-speed LZC and circuit size reduction because these circuits detect the pattern of an arrangement of zeros directly from an encoded decimal floating point number without using an intervening decoding process.

According to at least one embodiment, LZC is provided that can be performed at high speed with respect to an encoded decimal floating-point number.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An arithmetic circuit, comprising:
a storage circuit configured to store a decimal floating point number in an encoded state;
a detection circuit configured to detect a pattern of an arrangement of zeros from a bit pattern of the decimal floating point number by decoding the decimal floating point number stored in the storage circuit; and
a leading-zero-count circuit configured to generate data indicative of a number of consecutive zeros starting from a most significant bit or from a least significant bit in a significand of the decimal floating point number in response to a detection result obtained by the detection circuit.

2. The arithmetic circuit as claimed in claim 1, wherein the detection circuit includes:
a zero detecting circuit configured to detect presence and absence of zero in each digit to output data indicative of the presence and absence of zero in each digit; and
a pattern detecting circuit configured to detect the pattern of an arrangement of zeros based on the data indicative of the presence and absence of zero in each digit.

3. The arithmetic circuit as claimed in claim 1, wherein the decimal floating point number is in a DPD format specified in IEEE754-2008, and the detection circuit is configured to produce a bit value indicative of presence and absence of zero in each digit by performing a logical sum operation with respect to a plurality of bits of the bit pattern of the decimal floating point number in the DPD format.

4. The arithmetic circuit as claimed in claim 1, wherein the decimal floating point number is in an Oracle-NUMBER format, and the detection circuit is configured to produce a bit value indicative of presence and absence of zero in each digit by determining whether the bit pattern of the decimal floating point number in the Oracle-NUMBER format indicates a value failing within a range of values corresponding to zero in each digit.

5. An arithmetic method, comprising:
detecting a pattern of an arrangement of zeros from a bit pattern of a decimal floating point number in an encoded state by decoding the decimal floating point number; and
generating data indicative of a number of consecutive zeros starting from a most significant bit or from a least significant bit in a significand of the decimal floating point number in response to a result of detecting the pattern of an arrangement of zeros.
